(19) United States
(12) Patent Application Publication
(10) Pub. No.: US 2010/0240843 A1
(43) Pub. Date: Sep. 23, 2010

(54) PURGING DEVICES FOR USE IN POLYMERIZATION PROCESSES

(76) Inventors: Ralph Niels Hesson, Victoria, TX (US); J. S. Spinks, Walton, WV (US)

Correspondence Address: UNIVATION TECHNOLOGIES, LLC, 5555 SAN FELIPE, SUITE 1950, HOUSTON, TX, 77056, US

(21) Appl. No.: 12/405,532

(22) Filed: Mar. 17, 2009

(51) Int. Cl. C08F 2/34; B01J 19/00

(52) U.S. Cl. 526/68; 422/243

(57) ABSTRACT

One or more purging devices are provided which prevent buildup of polymer particles on valves used in the production of polyolefins. More particularly, embodiments of the present invention relate to purge devices which direct continuous gas flow onto the face of a ball valve located in a recycle stream to prevent resin buildup. Further embodiments of the present invention relate to polyolefin production processes employing such purging devices.

### FIELD OF INVENTION

Embodiments of the present invention generally relate to devices which prevent buildup of polymer particles on valves used in the production of polyolefins. More particularly, embodiments of the present invention relate to purge devices which direct continuous gas flow onto the face of a ball valve located in a recycle stream to prevent resin buildup on the face of the valve.

### BACKGROUND

Manufacturing processes for the production of polyolefins are widely known. Many such processes employ one or more product discharge vessels, which collect and separate polymer product exiting the polymerization reactor and then recycle reaction cycle gases that are entrained with discharged resin product back into the polymerization reactor. It is common to employ one or more valves in the recycle line to control flow of the recycle gas, and often such valves are ball valves. Due to the intermittent nature of gas flow through the recycle line, granular polymer particles which are entrained in the recycle gas have a tendency to build up on the face of such ball valves, resulting in reduced or inconsistent flow through the valve or, in some cases, complete plugging of the valve.

In the past, polyolefin manufacturers have had custom purging devices manufactured in an effort to reduce buildup of polymer resin on these ball valves. One prior example of these custom devices is machined from a steel block and incorporates a nozzle directed at the face of a ball valve which directs gas flow onto the face. Such custom purge devices are quite effective, but are also extremely costly. Therefore, there is a need in the art for purging devices that perform just as effectively as the previous custom-made devices, but which can be obtained at a much lower cost.

### SUMMARY

Embodiments of the present invention are directed to purging devices for use in polyolefin manufacturing processes. These devices are just as effective as prior known devices such as those described above, but are significantly less costly because they comprise standard piping components. In one or more embodiments of the present invention, the purging device prevents resin buildup on a valve located in a recycle line of a polyolefin manufacturing process by directing gas flow onto the face of the valve. In at least one embodiment, the device comprises a flanged pipe spool having an angled branch connection positioned at the top of the spool, wherein the connection is angled toward the face of the valve.

In a further embodiment of the present invention, a process for the production of polyolefins is provided. The process comprises one or more product discharge vessels for collection of polymer product exiting the reactor, the product discharge vessels having one or more gas recycle lines used to direct flow of reaction cycle gas from the product discharge vessels back to the reactor. In one or more embodiments, such recycle lines comprise one or more ball valves for regulation of gas flow, and further comprise a purging device located immediately prior to the one or more ball valves. The purge device directs gas flow onto the face of the valve through a branch connection angled toward the valve face, thus reducing or eliminating polymer buildup on the face of the valve.

### BRIEF DESCRIPTION OF THE DRAWINGS

FIG. 1 depicts a purging device for use in a polyolefin manufacturing process which prevents polymer buildup on the face of one or more valves located in one or more gas recycle streams of the process.

FIG. 2 depicts a flow diagram of an illustrative gas phase system for making polyolefin.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

### Purging Device

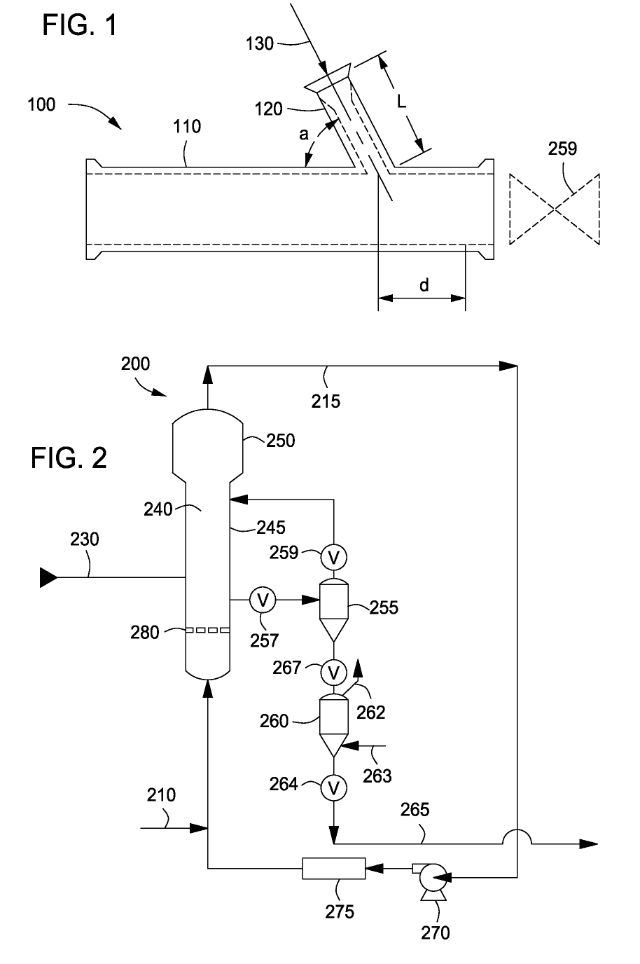

FIG. 1 depicts a schematic diagram of a purging device 100 in accordance with one or more embodiments described. In certain embodiments, purging device 100 is employed in a polyolefin manufacturing process, generally as part of a gas recycle line exiting a product discharge vessel (not shown in FIG. 1). In one or more embodiments, the purging device 100 comprises a flanged pipe spool 110 and an angled branch connection 120 positioned at the top of the spool. In certain embodiments, angled branch connection 120 is connected to flanged pipe spool 110 via set-in construction. Recycled gases flow from the product discharge vessel through flanged pipe spool 110 as they are returned to the reactor (not shown in FIG. 1).

Both of flanged pipe spool 110 and angled branch connection 120 are generally circular in cross-section, and the diameter of each may vary depending on the process in which the purging device 100 is used. For example, recycle lines in many polymerization processes may be 6″, 8″, or 10″ in diameter, depending upon the system capacity, and the diameter of flanged pipe spool 110 will generally be compatible with the diameter of such recycle line. In one or more embodiments, the diameters of flanged pipe spool 110 and angled branch connection 120 may be reduced with respect to the diameter of the recycle line, thus increasing the velocity of gas flowing through purging device 100. The ideal size and cross section of each of flanged pipe spool 110 and angled branch connection 120 may be readily determined by persons of skill in the art, taking into consideration many factors, including but not limited to the size and cross section of the gas recycle line to which purging device 100 is attached, the velocity of recycle gas through the recycle line, the nature of the recycled gas, and the dimensions of commercially available piping components.

In one or more embodiments, purging device 100 is located immediately before a valve 259. In at least one embodiment, valve 259 is a ball valve, and angled branch connection 120 is positioned at an angle (a) with respect to the flanged pipe spool 110 such that angled branch connection 120 is angled toward the face of valve 259. In some polymerization processes, recycled reaction gases that pass through purging device 100 and valve 259 will flow intermittently, thus allowing polymer particles which are entrained in the gas stream to build up on the face of valve 259. In certain embodiments, gas stream 130 enters angled branch connection 120 and is thereby directed onto the face of valve 259 to prevent buildup of polymer particles on the valve face.

The origin and composition of gas stream 130 are not critical to the design and operation of purging device 100 and will generally be determined by persons having skill in the art with reference to the requirements of the polymerization process in which purging device 100 is employed. For example, in certain embodiments gas stream 130 may be a fresh gas stream, or gas stream 130 may be directed to purging device 100 by diverting part of a gas stream from elsewhere in the polymerization process. The composition of gas stream 130 may be the same as the composition of recycled gas flowing through flanged pipe spool 110, or may be any other composition provided that such composition is compatible with the overall polymerization process and does not have a deleterious effect thereon.

The ideal angle (a) of angled branch connection 120 may be determined by persons skilled in the art depending upon the particular process and its conditions. In one or more embodiments, angle (a) is between 30° and 60° with respect to flanged pipe spool 110. In a further embodiment, angle (a) is approximately 45° with respect to flanged pipe spool 110.

In one or more embodiments, angled branch connection 120 is located at a position on flanged pipe spool 110 such that it is a minimum possible distance (d) from the face of valve 259. Such distance (d) will be determined by the physical limitations of the process components, but will typically be less than 300 mm from the face of valve 259. In one embodiment, angled branch connection is located at a position on flanged pipe spool 110 that is a distance (d) less than 200 mm from the face of valve 259. In further embodiments, distance (d) is less than 100 mm, or less than 89 mm.

In certain embodiments, the angle (a) of angled branch connection 120, the length (L) of angled branch connection 120 and the flow of gas stream 130 through angled branch connection 120 will be selected such that angled branch connection 120 is self-draining so as to prevent polymer particulates from accumulating in the purge connection.

### Polymerization Process

FIG. 2 depicts a flow diagram of an illustrative gas phase system for making polyolefin in which purging device 100 may be employed. In one or more embodiments, the system 200 includes a reactor 240 in fluid communication with one or more discharge tanks 255 (only one shown), surge tanks 260 (only one shown), recycle compressors 270 (only one shown), and heat exchangers 275 (only one shown). The polymerization system 200 can also include more than one reactor 240 arranged in series, parallel, or configured independent from the other reactors, each reactor having its own associated tanks 255, 260, compressors 270, recycle compressors 270, and heat exchangers 275 or alternatively, sharing any one or more of the associated tanks 255, 260, compressors 270, recycle compressors 270, and heat exchangers 275. For simplicity and ease of description, embodiments of the invention will be further described in the context of a single reactor train.

In one or more embodiments, the reactor 240 can include a reaction zone 245 in fluid communication with a velocity reduction zone 250. The reaction zone 245 can include a bed of growing polymer particles, formed polymer particles and catalyst particles fluidized by the continuous flow of polymerizable and modifying gaseous components in the form of make-up feed and recycle fluid through the reaction zone 245.

A feed stream or make-up stream 210 can be introduced into the polymerization system at any point. For example, the feed stream or make-up stream 210 can be introduced to the reactor fluid bed in the reaction zone 245 or to the expanded section 250 or to any point within the recycle stream 215. Preferably, the feed stream or make-up stream 210 is introduced to the recycle stream 215 before or after the heat exchanger 275. In FIG. 1, the feed stream or make-up stream 210 is depicted entering the recycle stream 215 after the heat exchanger 275.

The term “feed stream” as used herein refers to a raw material, either gas phase or liquid phase, used in a polymerization process to produce a polymer product. For example, a feed stream may be any olefin monomer including substituted and unsubstituted alkenes having two to 12 carbon atoms, such as ethylene, propylene, butene, pentene, 4-methyl-1-pentene, hexene, octene, decene, 1-dodecene, styrene, and derivatives thereof. The feed stream also includes non-olefinic gas such as nitrogen and hydrogen. The feeds may enter the reactor at multiple and different locations. For example, monomers can be introduced into the polymerization zone in various ways including direct injection through a nozzle (not shown in the drawing) into the bed. The feed stream can further include one or more non-reactive alkanes that may be condensable in the polymerization process for removing the heat of reaction. Illustrative non-reactive alkanes include, but are not limited to, propane, butane, isobutane, pentane, isopentane, hexane, isomers thereof and derivatives thereof.

The fluidized bed has the general appearance of a dense mass of individually moving particles as created by the percolation of gas through the bed. The pressure drop through the bed is equal to or slightly greater than the weight of the bed divided by the cross-sectional area. It is thus dependent on the geometry of the reactor. To maintain a viable fluidized bed in the reaction zone 245, the superficial gas velocity through the bed must exceed the minimum flow required for fluidization. Preferably, the superficial gas velocity is at least two times the minimum flow velocity. Ordinarily, the superficial gas velocity does not exceed 5.0 ft/sec and usually no more than 2.5 ft/sec is sufficient.

In general, the height to diameter ratio of the reaction zone 245 can vary in the range of from about 2:1 to about 5:1. The range, of course, can vary to larger or smaller ratios and depends upon the desired production capacity. The cross-sectional area of the velocity reduction zone 250 is typically within the range of about 2 to about 3 multiplied by the cross-sectional area of the reaction zone 245.

The velocity reduction zone 250 has a larger inner diameter than the reaction zone 245. As the name suggests, the velocity reduction zone 250 slows the velocity of the gas due to the increased cross sectional area. This reduction in gas velocity allows particles entrained in the upward moving gas to fall back into the bed, allowing primarily only gas to exit overhead of the reactor 240 through recycle gas stream 215.

The recycle stream 215 can be compressed in the compressor/compressor 270 and then passed through the heat exchanger 275 where heat is removed before it is returned to the bed. The heat exchanger 275 can be of the horizontal or vertical type. If desired, several heat exchangers can be employed to lower the temperature of the cycle gas stream in stages. It is also possible to locate the compressor downstream from the heat exchanger or at an intermediate point between several heat exchangers. After cooling, the recycle stream 215 is returned to the reactor 240. The cooled recycle stream absorbs the heat of reaction generated by the polymerization reaction.

Preferably, the recycle stream 215 is returned to the reactor 240 and to the fluidized bed through a gas distributor plate 280. A gas deflector 280 is preferably installed at the inlet to the reactor to prevent contained polymer particles from settling out and agglomerating into a solid mass and to prevent liquid accumulation at the bottom of the reactor as well to facilitate easy transitions between processes which contain liquid in the cycle gas stream and those which do not and vice versa. An illustrative deflector suitable for this purpose is described in U.S. Pat. No. 4,933,415 and 6,627,713.

A catalyst or catalyst system may be introduced to the fluidized bed within the reactor 240 through one or more injection nozzles (not shown in the drawing) in fluid communication with stream 230. The catalyst or catalyst system is preferably introduced as pre-formed particles in one or more liquid carriers (i.e. a catalyst slurry). Suitable liquid carriers include mineral oil and liquid hydrocarbons including but not limited to propane, butane, isopentane, hexane, heptane and octane, or mixtures thereof. A gas that is inert to the catalyst slurry such as, for example, nitrogen or argon can also be used to carry the catalyst slurry into the reactor 240. In one or more embodiments, the catalyst or catalyst system can be a dry powder. In one or more embodiments, the catalyst or catalyst system can be dissolved in the liquid carrier and introduced to the reactor 240 as a solution.

Under a given set of operating conditions, the fluidized bed is maintained at essentially a constant height by withdrawing a portion of the bed as product at the rate of formation of the particulate polymer product. Since the rate of heat generation is directly related to the rate of product formation, a measurement of the temperature rise of the fluid across the reactor (the difference between inlet fluid temperature and exit fluid temperature) is indicative of the rate of particulate polymer formation at a constant fluid velocity if no or negligible vaporizable liquid is present in the inlet fluid.

On discharge of particulate polymer product from reactor 240, it is desirable and preferable to separate fluid from the product and to return the fluid to the recycle line 215. In one or more embodiments, this separation is accomplished when fluid and product leave the reactor 240 and enter the product discharge tanks 255 (one is shown) through valve 257. Positioned above and below the product discharge tank 255 are valves 259 and 267. The valve 267 allows passage of product into the product surge tanks 260 (only one is shown).

In at least one embodiment, to discharge particulate polymer from reactor 240, valve 257 is opened while valves 259, 267 are in a closed position. Product and fluid enter the product discharge tank 255. Valve 257 is closed and the product is allowed to settle in the product discharge tank 255. Valve 259 is then opened permitting fluid to flow from the product discharge tank 255 to the reactor 245. Valve 259 is then closed and valve 267 is opened and any product in the product discharge tank 255 flows into the product surge tank 260. Valve 267 is then closed. Product is then discharged from the product surge tank 260 through valve 264. The product can be further purged via purge stream 263 to remove residual hydrocarbons and conveyed to a pelletizing system or to storage (not shown) via stream 265. The particular timing sequence of the valves 257, 259, 267, 264 is accomplished by the use of conventional programmable controllers which are well known in the art. Valves 257, 259, 264, and 267 may be of any type generally used in polymer manufacturing processes, such as conventional valves, ball valves, or a combination thereof. In one embodiment of the present invention, one or all of valves 257, 259, 264, and 267 are ball valves, which may be preferred for use in the illustrated process as they are designed to have minimum restriction to flow when opened.

In at least one embodiment, purging device 100 (not shown in FIG. 2) is positioned at the outlet of product discharge tank 255 and immediately before valve 259. The purge device 100 is described in more detail above, with reference to FIG. 1.

Another preferred product discharge system which can be alternatively employed is that disclosed and claimed in U.S. Pat. No. 4,621,952. Such a system employs at least one (parallel) pair of tanks comprising a settling tank and a transfer tank arranged in series and having the separated gas phase returned from the top of the settling tank to a point in the reactor near the top of the fluidized bed. Purging device 100 may be employed in this system in a manner similar to that described above.

The fluidized-bed reactor is equipped with an adequate venting system (not shown) to allow venting the bed during start up and shut down. The reactor does not require the use of stirring and/or wall scraping. The recycle line 215 and the elements therein (compressor 270, heat exchanger 275) should be smooth surfaced and devoid of unnecessary obstructions so as not to impede the flow of recycle fluid or entrained particles.

Various techniques for preventing fouling of the reactor and polymer agglomeration can be used. Illustrative of these techniques are the introduction of finely divided particulate matter to prevent agglomeration, as described in U.S. Pat. Nos. 4,994,534 and 5,200,477; the addition of negative charge generating chemicals to balance positive voltages or the addition of positive charge generating chemicals to neutralize negative voltage potentials as described in U.S. Pat. No. 4,803,251. Antistatic substances may also be added, either continuously or intermittently to prevent or neutralize electrostatic charge generation. Condensing mode operation such as disclosed in U.S. Pat. Nos. 4,543,399 and 4,588,790 can also be used to assist in heat removal from the fluid bed polymerization reactor.

The conditions for polymerizations vary depending upon the monomers, catalysts, catalyst systems, and equipment availability. The specific conditions are known or readily derivable by those skilled in the art. For example, the temperatures are within the range of from about −10° C. to about 120° C., often about 15° C. to about 110° C. Pressures are within the range of from about 0.1 bar to about 100 bar, such as about 5 bar to about 50 bar, for example. Additional details of polymerization can be found in U.S. Pat. No. 6,627,713, which is incorporated by reference at least to the extent it discloses polymerization details.

Considering the polymer product stream 265, the polymer can be or include any type of polymer or polymeric material. Illustrative polymers can include polyolefins, polyamides, polyesters, polycarbonates, polysulfones, polyacetals, polylactones, acrylonitrile-butadiene-styrene resins, polyphenylene oxide, polyphenylene sulfide, styrene-acrylonitrile resins, styrene maleic anhydride, polyimides, aromatic polyketones, or mixtures of two or more of the above. Suitable polyolefins can include, but are not limited to, polymers comprising one or more linear, branched or cyclic C2 to C40 olefins, preferably polymers comprising propylene copolymerized with one or more C3 to C40 olefins, preferably a C3 to C20 alpha olefin, more preferably C3 to C10 alpha-olefins. More preferred polyolefins include, but are not limited to, polymers comprising ethylene including but not limited to ethylene copolymerized with a C3 to C40 olefin, preferably a C3 to C20 alpha olefin, more preferably propylene and or butene.

Preferred polymers include homopolymers or copolymers of C2 to C40 olefins, preferably C2 to C20 olefins, preferably a copolymer of an alpha-olefin and another olefin or alpha-olefin (ethylene is defined to be an alpha-olefin for purposes of this invention). Preferably, the polymers are or include homopolyethylene, homopolypropylene, propylene copolymerized with ethylene and or butene, ethylene copolymerized with one or more of propylene, butene or hexene, and optional dienes. Preferred examples include thermoplastic polymers such as ultra low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymer of propylene and ethylene and/or butene and/or hexene, elastomers such as ethylene propylene rubber, ethylene propylene diene monomer rubber, neoprene, and blends of thermoplastic polymers and elastomers, such as for example, thermoplastic elastomers and rubber toughened plastics.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A device for preventing resin buildup on a valve in a recycle line of a polyolefin manufacturing process, wherein the apparatus comprises a flanged pipe spool having an angled branch connection positioned at the top of the spool, said connection being angled toward the valve.

2. The device of claim 1, wherein the angled branch connection is at an angle of approximately 45 degrees with respect to the pipe spool.

3. The device of claim 1, wherein the valve is a ball valve.

4. The device of claim 3, wherein the angled branch connection is located at a position on the pipe spool that is less than 100 mm from the face of the ball valve.

5. The device of claim 4, wherein the angled branch connection is at the minimum practical distance from the face of the ball valve.

6. The device of claim 1, wherein the angled branch connection is self-draining.

7. A process for the production of polyolefins comprising one or more product discharge vessels having one or more gas recycle lines, wherein at least one recycle line comprises one or more ball valves for regulation of gas flow, and wherein the recycle line further comprises the device of any one of the preceding claims.
